(19) United States
(12) Patent Application Publication
(10) Pub. No.: US 2018/0004277 A1
(43) Pub. Date: Jan. 4, 2018

(54) INFORMATION PROCESSING APPARATUS, INFORMATION PROCESSING METHOD, AND RECORDING MEDIUM ON WHICH COMPUTER-READABLE PROGRAM IS RECORDED

(71) Applicant: CANON KABUSHIKI KAISHA, Tokyo (JP)

(72) Inventors: Keisuke Matsui, Tokyo (JP); Yasusaburo Degura, Tokyo (JP); Hiroshi Moritomo, Tokyo (JP)

(21) Appl. No.: 15/637,970

(22) Filed: Jun. 29, 2017

(30) Foreign Application Priority Data
Jul. 4, 2016 (JP) 2016-132872

(51) Int. Cl. G06F 1/32; G06F 9/06; G06F 13/40; G06F 13/42; G06F 1/26

(52) U.S. Cl. CPC G06F 1/3253; G06F 1/3287; G06F 13/4072; G06F 13/4282; G06F 9/06; G06F 1/26; G06F 13/40

(57) ABSTRACT

An information processing apparatus includes a first connection unit, an acquisition unit configured to obtain capability information about an external apparatus via the first connection unit, a power control unit configured to control one of a plurality of states based on the obtained capability information, the plurality of states including a first state in which power is transmitted to the external apparatus and a second state in which power is received from the external apparatus, and a notification unit configured to, when the power control unit performs the control, distinguish and make a notification of the first state, the second state, and a third state different from the first and second states. When performing power control based on a power control policy, the information processing apparatus then makes a distinctive notification of a power transmission state and a power reception state, or makes a distinctive notification for each power level.

### BACKGROUND

### Field

The present disclosure relates to an information processing apparatus, an information processing method, and a recording medium on which a computer-readable program is recorded.

### Description of the Related Art

For a wired communication interface for connecting to an information processing apparatus, there are techniques by which power can be transferred in parallel with data transfer. Typical examples include Universal Serial Bus (USB).

If apparatuses are connected via a cable, a technique called USB Power Delivery (USB-PD) enables determining which apparatus supplies power to which connected apparatus more freely than with conventional USB apparatuses. Conventional USB apparatuses not supporting USB-PD have been only capable of power supply from a host apparatus (host) to a peripheral apparatus (device).

As the degree of freedom of power supply control increases, the possibility of power supply unintended by a user occurring can increase as well. Some countermeasures may therefore be needed to avoid such unintended power supply.

For example, Japanese Patent No. 5631900 discusses a technique for displaying a charge condition (charging state, fully charged state) of an electric vehicle.

If a cable plugged into a USB-PD port (connection unit) capable of both power transmission and power reception is connected to an external apparatus, power control may fail to be performed as intended by the user.

For example, power may be transmitted in a direction that is the reverse of a power transmission direction. intended by the user. As another example, power control may be performed at a power level different from that intended by the user.

### SUMMARY

According to various embodiments, an information processing apparatus includes a first connection unit, an acquisition unit configured to obtain capability information about an external apparatus from the external apparatus via the first connection unit, a power control unit configured to control one of a plurality of states based on the capability information obtained by the acquisition unit, the plurality of states including a first state in which power is transmitted to the external apparatus via the first connection unit and a second state in which power is received from the external apparatus via the first connection unit, and a notification unit configured to, when the power control unit performs the control, distinguish and make a notification of the first state, the second state, and a third state different from the first and second states.

By using various embodiments of the present disclosure, the user can more easily recognize situations where power control unintended by the user is occurring.

Further features will become apparent from the following description of exemplary embodiments with reference to the attached drawings.

### BRIEF DESCRIPTION OF THE DRAWINGS

The accompanying drawings, which are incorporated by reference in and constitute a part of the specification, illustrate exemplary embodiments, features and aspects of various embodiments of the present disclosure and, together with the description, serve to explain the principles described in the present disclosure.

FIG. 1 is a flowchart illustrating an outline of processing for determining a power control policy of an information processing apparatus according to one embodiment.

FIGS. 2A and 2B are schematic diagrams respectively illustrating a configuration of the information processing apparatus and a configuration of a Universal Serial Bus (USB) control unit according to one embodiment.

FIGS. 3A and 3B are schematic diagrams respectively illustrating a pin arrangement of a receptacle of the USB control unit and a pin arrangement of a plug according to one embodiment.

FIGS. 4A, 4B, 4C, and 4D are schematic diagrams respectively illustrating a configuration channel (CC) packet format, a CC message format, message types, and contents of capability information according to one embodiment.

FIG. 5 is a schematic diagram illustrating a display screen for determining the power control policy according to one embodiment.

FIGS. 6A and 6B are schematic diagrams respectively illustrating a display screen for setting a condition to stop power transmission from the information processing apparatus and a display screen for setting a condition to stop power reception by the information processing apparatus according to one embodiment.

FIG. 7 is a schematic diagram illustrating a pulldown menu for setting a data transfer policy according to one embodiment.

FIG. 8 is a flowchart illustrating details of power control processing according to one embodiment.

FIG. 9 is a schematic diagram illustrating how two apparatuses are connected to enable power transmission or power reception according to one embodiment.

FIG. 10 is a schematic diagram illustrating an overview of contents stored in a configuration register and a status register according to one embodiment.

FIGS. 11A to 11I are schematic diagrams illustrating a screen displaying details of power control according to one embodiment.

FIGS. 12A and 12B are schematic diagrams respectively illustrating connection units equipped with a light-emitting diode (LED) and cables each equipped with an LED according to one embodiment.

### DESCRIPTION OF THE EMBODIMENTS

Exemplary embodiments, features and aspects will now be described in detail below with reference to the attached drawings.

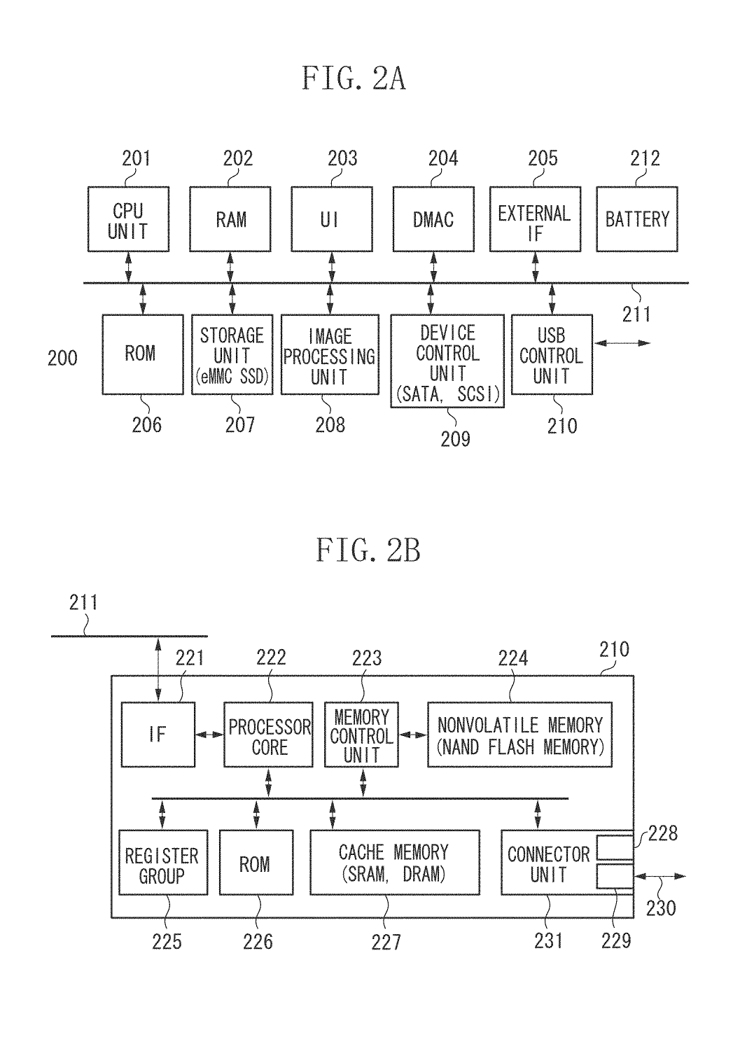

A first exemplary embodiment of the present disclosure will be described in detail below with reference to the drawings. Initially, a hardware configuration of the first exemplary embodiment will be described with reference to FIGS. 2A and 2B.

FIG. 2A is a schematic diagram illustrating a configuration of an information processing apparatus 200 to which an exemplary embodiment of the present disclosure is applied. Examples of the information processing apparatus 200 may include portable devices such as a laptop computer, a tablet computer, a smartphone, and a digital camera. However, an exemplary embodiment of the present disclosure may also be applied to other devices. A read-only memory (ROM) 206 stores a program for implementing a flow process for present exemplary embodiment described below. A central processing unit (CPU) unit 201 uses a direct memory access controller (DMAC) 204 to load the program in the ROM 206 into a random access memory (RAM) 202, reads the program from the RAM 202, and executes processing including the contents of the flowchart to be described below. The RAM 202 may include a synchronous dynamic random access memory (SDRAM) compliant with a double data rate (DDR) standard.

A user interface (UI) 203 functions as an acceptance unit for accepting instructions from a user, and allows the user to use various functions of the information processing apparatus 200. The UI 203 may include a plurality of buttons, a display, and a touch panel. An external interface (IF) 205 includes wired and wireless network interfaces and external interfaces such as USB and Peripheral Component Interface Express (PCIe) interfaces. A storage unit 207 includes a storage device functioning as a high-capacity nonvolatile memory. Examples thereof include a solid state drive (SSD) and an embedded Multi Media Card (eMMC). The storage unit 207 stores code of an operating system (OS). An image processing unit 208 is a graphic accelerator (or graphics processing unit (GPU)) that performs various types of image processing according to requests from the CPU unit 201.

A bus 211 is a bus for communicably connecting components. A device control unit 209 includes a chipset for controlling data exchange between the CPU unit 201 and other components.

FIG. 2B is a schematic diagram illustrating a detailed configuration of a USB control unit 210 that functions as a power control unit in the present exemplary embodiment. A nonvolatile memory 224 includes a NAND flash memory (hereinafter, referred to simply as a flash memory), and can retain information in a nonvolatile manner without supply of electric charges. A ROM 226 stores programs for controlling the USB control unit 210. A processor core 222 reads and executes the programs. For example, the ROM 226 stores programs for implementing a data transfer function compliant with a USB standard and data transfer by the Media Transfer Protocol (MTP) and Picture Transfer Protocol (PTP) to be described below, a program for implementing a power control function, and device information (device identifier (ID) and vendor ID) about the information processing apparatus 200.

A register group 225 includes a general-purpose register, a configuration register, and a status register. The general-purpose register stores intermediate values when the processor core 222 performs calculations. The configuration register stores settings (parameters and power control policies) for the processor core 222 to control the USB control unit 210. The status register stores information by which the processor core 222 indicates a state of the information processing apparatus 200 based on information from the CPU unit 201. Details of the configuration register and the status register will be described below. An IF 221 connects the bus 211 and the processor core 222. For example, the IF 221 interprets information transmitted via the bus 211 and transmits the resultant to the processor core 222. A cache memory 227 includes a static random access memory (SRAM) and a dynamic random access memory (DRAM). The cache memory 227 temporarily stores data to be written to the nonvolatile memory 224 and data read from the nonvolatile memory 224.

A memory control unit 223 includes a controller for controlling the flash memory included in the nonvolatile memory 224. The memory control unit 223 performs read and write processing on the flash memory of the nonvolatile memory 224 based on instructions from the processor core 222. More specifically, the memory control unit 223 includes an address register and a command register. The address register stores an address of the nonvolatile memory 224 to be accessed based on an access instruction from the processor core 222. The command register stores a command indicating the content of the access. The memory control unit 223 controls the nonvolatile memory 224 according to the contents stored in these registers.

A connector unit 231 includes one or more receptacles serving as USB Type-C connection units (connectors). The connector unit 231 includes a 4b5b codec and biphase mark code (BMC) codec (not illustrated). The connector unit 231 can obtain, decode, and transfer information symbolized by 4b5b conversion and information encoded by BMC to the processor core 222. The connector unit 231 according to the present exemplary embodiment includes a connection unit 228 (first connection unit) and a connection unit 229 (second connection unit). The connection units 228 and 229 are each configured to function as a receptacle into which a USB Type-C plug can be inserted. A cable 230 is a cable compatible with USB-PD. A plug (male) at an end of the cable 230 can be attached to and detachable from a receptacle (female) of the connector unit 231. The other end of the cable 230 is connected to various devices. The connector unit 231 is configured so that power received from outside via the cable 230 can be supplied to a battery 212.

The battery 212 is a lithium ion rechargeable battery. The battery 212 functions as a power supply for supplying direct-current (DC) power to the information processing apparatus 200. The battery 212 can store power received from the connector unit 231 and an alternating-current (AC) power supply (not illustrated).

The nonvolatile memory 224 and the ROM 226 hold memory contents even after the information processing apparatus 200 is powered off. Other components such as the processor core 222, the register group 225, and the cache memory 227 lose their memory contents by power-off or a reset operation.

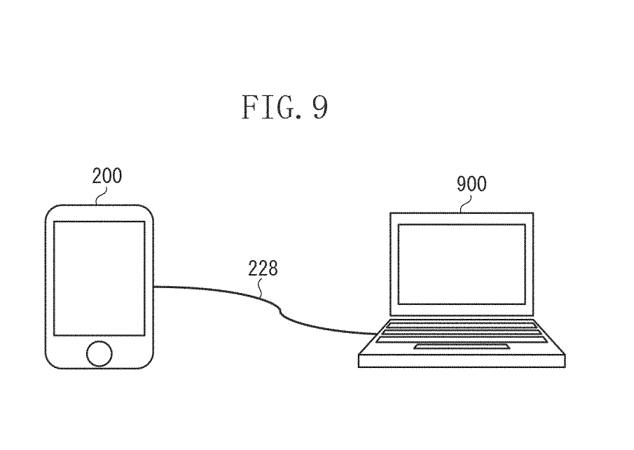

FIG. 9 illustrates a configuration with which the information processing apparatus 200 implements processing of an exemplary embodiment of the present disclosure. FIG. 9 is a schematic diagram illustrating how the information processing apparatus 200 and another information processing apparatus 900 (hereinafter, referred to as an external apparatus 900) are connected to be capable of power transmission or power reception in a wired manner. The external apparatus 900 has functions similar to those of the configurations illustrated in FIGS. 2A and 2B. A detailed description thereof will be omitted.

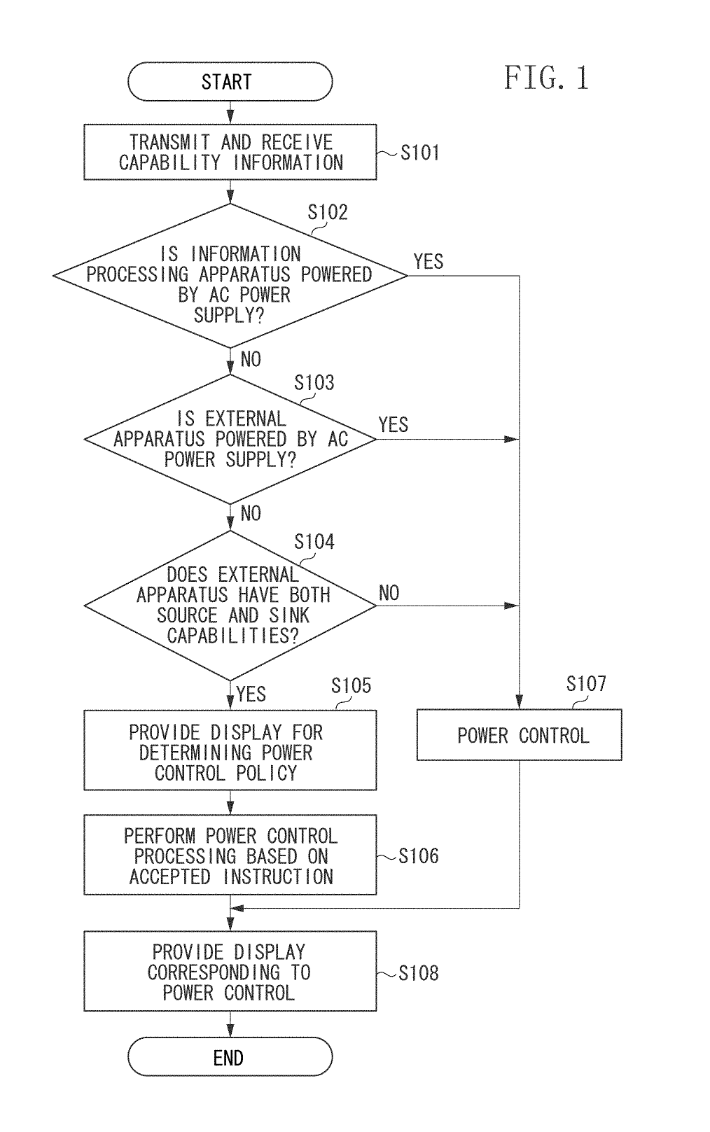

Next, an operation of the information processing apparatus 200 according to the present exemplary embodiment will be described with reference to FIG. 1. FIG. 1 is a flowchart illustrating an outline of processing by which the information processing apparatus 200 determines a power control policy after the information processing apparatus 200 is connected using a USB connection with the external apparatus 900 and control communication is established. In the present exemplary embodiment, a power control policy refers to a control policy including how the information processing apparatus 200 transmits power to the external apparatus 900 or how the information processing apparatus 200 receives power from the external apparatus 900.

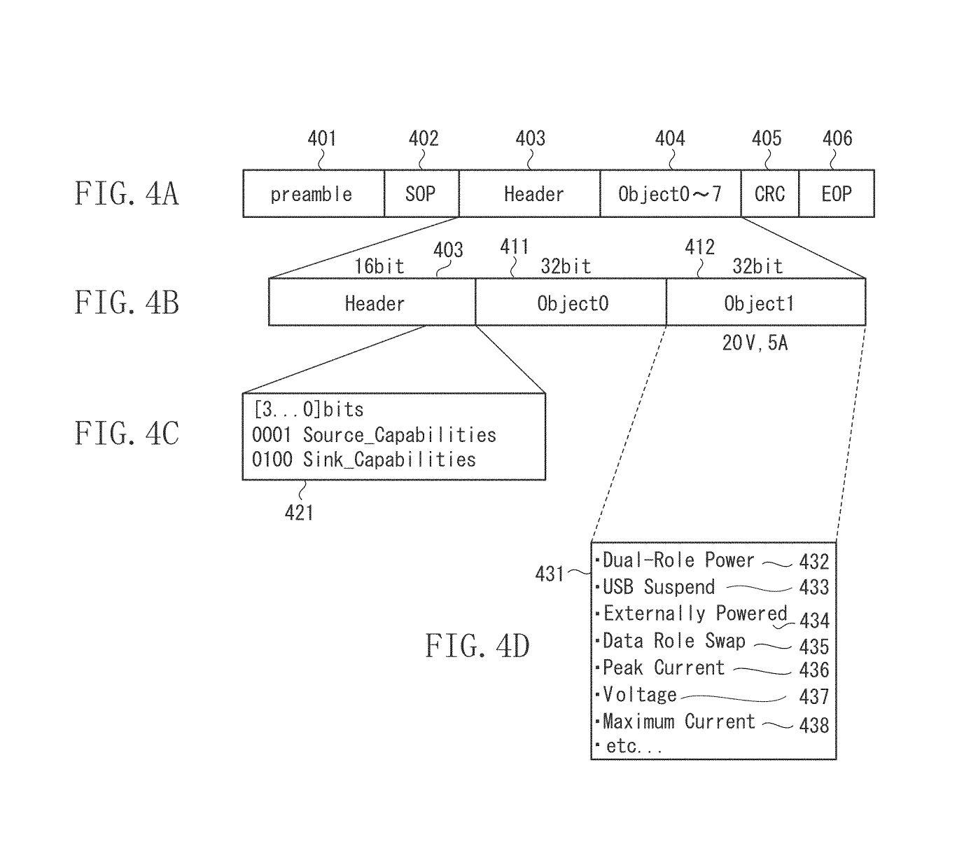

Referring to FIG. 1, in step S101, the processor core 222 of the information processing apparatus 200 transmits capability information about the information processing apparatus 200 to the external apparatus 900 and receives capability information about the external apparatus 900 from the external apparatus 900 via a configuration channel (CC) pin of a Type-C connector of the connector unit 231. The received capability information. is stored in the cache memory 227. In the present exemplary embodiment, the capability information includes power transmission capability information and power reception capability information. The power transmission capability information describes how the information processing apparatus 200 can supply power in a power transmission state (first state) in which the information processing apparatus 200 functions as a power transmission device source). The power reception capability information describes how the information processing apparatus 200 receives power and operates in a power reception state (second state) in which the information processing apparatus 200 functions as a power reception device sink). Details of the capability information will be described below with reference to the packet format of FIGS. 4A to 4D.

In step S102, the processor core 222 of the information processing apparatus 200 refers to the information in the status register of the register group 225, and determines whether power is supplied from an external power supply different from the external apparatus 900 connected via the connector unit 231. For example, the processor core 222 determines whether the information processing apparatus 200 is powered by an AC power supply (e.g., an AC-DC adapter or a wall wart). If the power transmission capability information transmitted from the information processing apparatus 200 to the external apparatus 900 in step S101 indicates that an. Externally Powered bit (external power supply information 434 to be described below) is disabled, the processor core 222 may determine YES. If power is supplied from an external power supply different from the external apparatus 900 (YES in step S102), the processing proceeds to step S107. If “No” in step 102, the processing proceeds to step S103.

In step S103, the processor core 222 refers to the cache memory 227 and determines whether the external apparatus 900 is powered by an AC power supply. More specifically, the processor core 222 determines whether an Externally Powered bit included in the capability information received from the external apparatus 900 indicates disabled. If the external apparatus 900 is powered by an AC power supply (YES in step S103), the processing proceeds to step S107. If “No” in step 103, the processing proceeds to step S104.

In step S104, the processor core 222 refers to the cache memory 227 and determines whether the external apparatus 900 has both power transmission device and power reception device capabilities. More specifically, the processor core 222 determines whether a Dual-Role Power bit (power role information 432 to be described below) included in the capability information received from the external apparatus 900 indicates enabled. If the external apparatus 900 has both the power transmission device and power reception device capabilities (YES in step S104), the processing proceeds to step S105.

In step S105, the processor core 222 performs control to provide display for determining the power control policy. More specifically, the processor core 222 interrupts the CPU of the CPU unit 201. The interrupted CPU unit 201 controls the UI 203 to provide display for accepting an instruction for the power control policy from the user (details of the power control policy will be described below). The image processing unit 208 may perform part of drawing processing for display. The instruction from the user includes information for determining at least one of the followings: “transmit power”, “receive power”, and “neither transmit nor receive power”. If an instruction is accepted from the user, the processing proceeds to step S106.

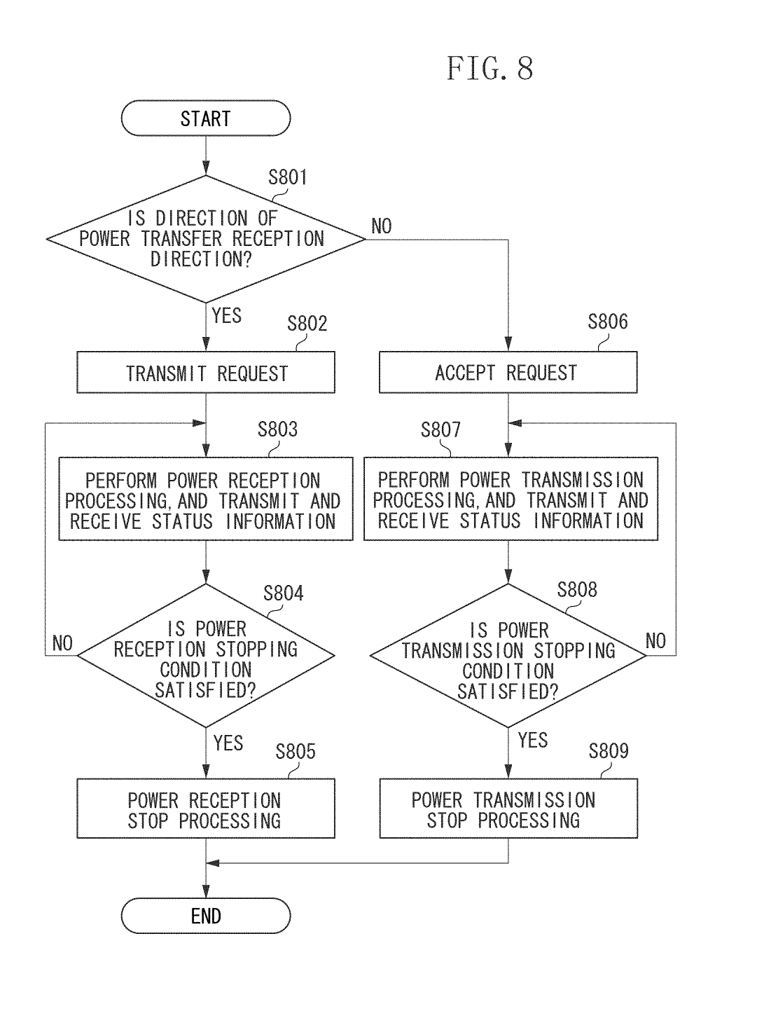

In step S106, the processor core 222 determines the power control policy based on the instruction accepted from user, and writes the contents of the determined power control policy into the configuration register of the register group 225. The processor core 222 then performs power control processing based on the determined power control policy. Details of the power control processing will be described below with reference to FIG. 8. Before performing the power control processing, the processor core 222 may access the configuration register of the register group 225 to cancel a Dual Role setting of the information processing apparatus 200. By this processing, the Dual Role setting is canceled until the processor core 222 is reset. For example, it the USB control unit 210 accepts a reset request from the external apparatus 900, the processor core 222 resets itself to initialize the contents of the register group 225. The Dual Role setting is thereby restored. If an instruction to “neither transmit nor receive power” is accepted from the user in step S105, the processing of step S106 is omitted.

If yes in step S102 or S103, or no in S104 (YES in step S102 or S103, or No in S104), the processing proceeds to step S107. In step S107, the processor core 222 controls the information processing apparatus 200 as a power transmission device if the information processing apparatus 200 is powered by an AC power supply. The processor core 222 controls the information processing apparatus 200 as a power reception device if the external apparatus 900 is powered by an AC power supply. If the external apparatus 900 has either one of the power transmission device and power reception device capabilities (the power role information 432 to be described below is disabled), the processor core 222 controls the information processing apparatus 200 as an apparatus corresponding to the capability of the external apparatus 900 (as a power reception device if the external apparatus 900 is a power transmission device, and as a power transmission device if the external apparatus 900 is a power reception device).

In step S108, the UI 203 provides display corresponding to the power control performed in step S106 or S107. Details of display content corresponding to the power control are described below.

### <Display Contents Corresponding to Power Control>

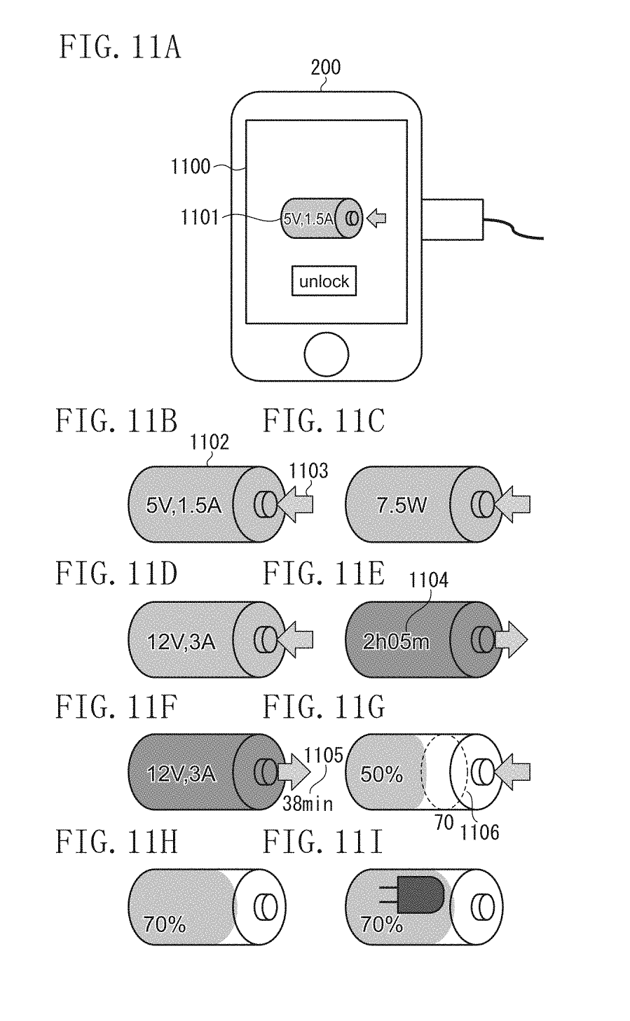

FIGS. 11A to 11I are schematic diagrams illustrating a screen on which the UI 203 of the information processing apparatus 200 distinguishes a power transmission state, a power reception state, a battery driven state, and a power level and displays icons according to the power control, in step S108. FIG. 11A illustrates a lock screen 1100 and an icon 1101. The icon 1101 represents an overview of power control. Suppose that the information processing apparatus 200 is configured to be able to receive or transmit power at a plurality of power levels including 5 or 12 V and 3 A.

FIGS. 11B to 11I illustrate examples of the icon 1101. In the example of FIG. 11E, a power display 1102 is superimposed and displayed on the icon 1101. The icon (arrow) 1101 indicates that the information processing apparatus 200 is being charged. The power display 1102 of FIG. 11B indicates a power value (5 V, 1.5 A) of power that the information processing apparatus 200 is receiving in terms of a voltage value and a current value. In the example of FIG. 11C, the power display 1102 indicates the power value in terms of power per unit time.

The power display 1102 of FIG. 11D indicates that the power value of the power the information processing apparatus 200 is received is 12 V and 3 A. The arrow 1103 of FIG. 11E indicates that the information processing apparatus 200 is transmitting power. A time display 1104 indicates that power can be supplied for 2 hours 5 minutes at the value of power the information processing apparatus 200 is currently supplying. If the arrow 1103 is in an opposite direction, the time display 1104 indicates the time needed for full charge.

A condition display 1105 of FIG. 11F indicates a power transmission stopping condition to be described below. The condition display 1105 indicates that power transmission will stop in 38 minutes. A condition display 1106 of FIG. 11G indicates a power reception stopping condition to be described below. The condition display 1106 indicates that the power reception will stop at 70%.

In the present exemplary embodiment, the icon 1101 is displayed on the lock screen 1100. However, the icon 1101 may be displayed during a normal operation. The icon 1101 may be touched by the user to switch between the display formats illustrated in FIG. 11B to 11G. The arrow 1103 may be touched by the user to switch between the power reception state and the power transmission state. The condition displays 1105 and 1106 may be slid to adjust the power transmission stopping condition and the power reception stopping condition. For example, if the user touches and slides the condition display 1105 upwards, the stop time is extended. If the user touches and slides the condition display 1105 downward, the stop time is reduced.

FIG. 11H illustrates a state in which power is neither transmitted nor received via the connector unit 231, and power is not received from an AC power supply, either (i.e., battery driven state). A state in which power is not received from an AC power supply refers to, for example, when a power supply plug accompanying the AC power supply of the information processing apparatus 200 is not plugged into the outlet. FIG. 11I illustrates a state in which power is neither transmitted nor received via the connector unit 231, but power is received from an AC power supply via a path different from the connector unit 231. If power is received from an AC power supply, the information processing apparatus 200 is in an AC power supply driven state. The plug notification of FIG. 11I may be superimposed and displayed in FIGS. 11E and 11F. It is technically undesirable to configure the information processing apparatus 200 so as to receive power by USB-PD and from an AC power supply simultaneously. The plug notification of FIG. 11I therefore does not need to be superimposed or displayed in FIGS. 11B to 11D and 11G. The reason for the technical undesirability is that the circuitry becomes complicated if power reception from an AC power supply and power reception by USB-PD are allowed to occur simultaneously. In addition, an overvoltage protection circuit may be needed. The components may need to be designed to have higher allowable voltages.

### <Power Control Policy>

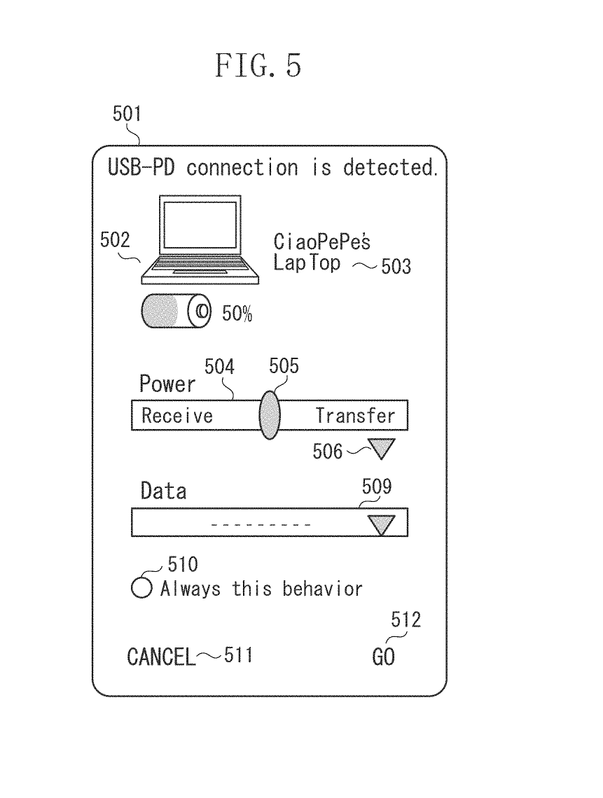

FIG. 5 illustrates an example of a setting screen that the UI 203 displays in step S105 of FIG. 1. In the present exemplary embodiment, the UI 203 is a capacitive touch panel.

The UI 203 displays a window 501 in response to an interrupt from the USB control unit 210. An icon section 502 displays an icon indicating the type of the external apparatus 900 and an icon indicating the remaining battery level of the external apparatus 900. A name 503 is a name of the external apparatus 900. Device information (device ID or vendor ID) about the external apparatus 900 may be displayed as the name 503.

A slide bar 504 is used to determine the power control policy of the information processing apparatus 200. The user can horizontally move a slider 505 on the slide bar 504 to select conditions “transmit power” and “receive power” as power control policies. The user can select a condition “neither transmit nor receive power” by not moving the slider 505.

A button 506 accepts the user's touch to display options for setting the power control policy in more detail (details will be described below).

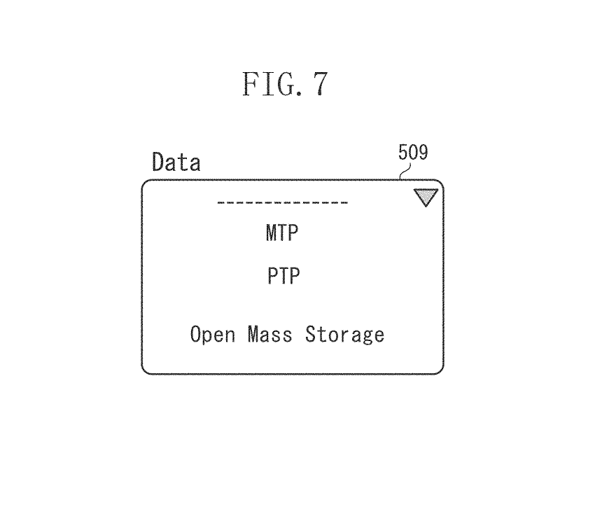

A pulldown section 509 accepts the user's touch to display options for setting a data transfer policy in more detail (details will be described below with reference to FIG. 7).

A radio button 510 can make a setting to cause the apparatus displayed in the name 503 to “store the selections made by the user on the window 501 and skip a call for the window 501 in step S105 of FIG. 1 next time”.

A cancel button 511 is a button for rejecting the settings made from the window 501. An execution button 512 is a button for reflecting the settings made via the window 501.

If the user's touch on the execution button 512 is accepted with the setting of the radio button 510 enabled, the processor core 222 stores device setting information associating the condition set by the user via the window 501 and the device information into the nonvolatile memory 224.

Although omitted in the description of FIG. 1, if the processing proceeds to step S105, the processor core 222 searches the nonvolatile memory 224 by using the device information as a query. If there is a hit for the search, there is device setting information previously set by the user in the nonvolatile memory 224. The processor core 222 performs the control of step S106 based on the device setting information stored in the hit entry.

When the device setting information stored in the nonvolatile memory 224 is used, the user may be notified of the use of the device setting information and a re-setting button for a predetermined time by a pop-up so that the user is prompted to re-set the device setting information. If the re-setting button is detected to be touched by the user, the processor core 222 performs the processing from step S105 again without searching the nonvolatile memory 224.

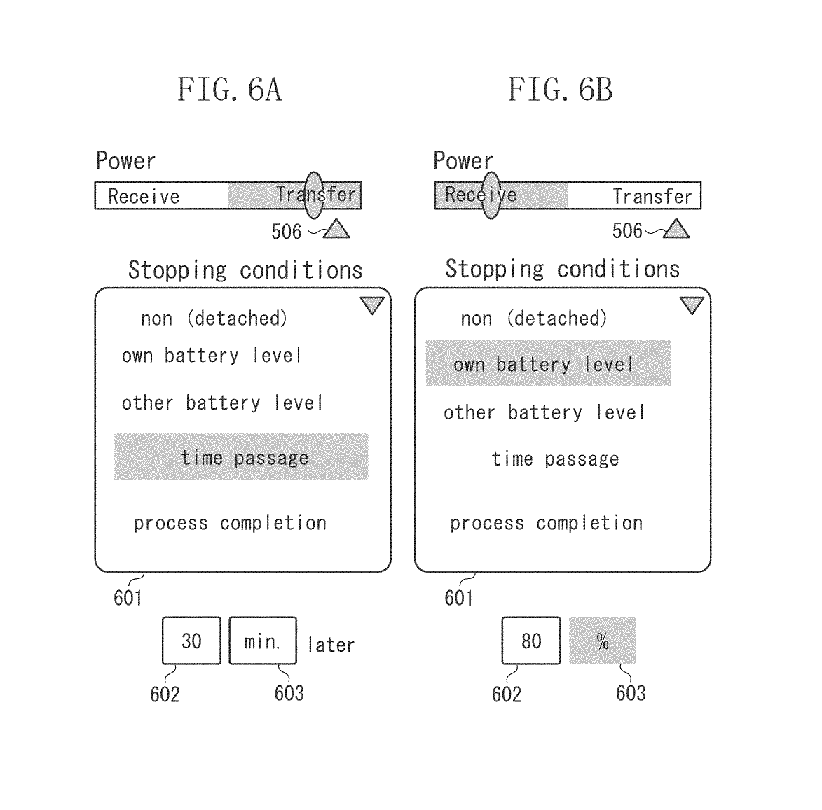

FIG. 6A illustrates part a screen further displayed on the window 501 when the slide bar 504 is operated to select the setting that the information processing apparatus 200 transmits power and the button 506 is operated to choose to make detailed settings. A pulldown section 601 presents a selectable list of conditions (power transmission stopping conditions) for stopping power transmission by the information processing apparatus 200.

“Non (detached)” is a condition selected in an initial state. For example, “non (detached)” refers to a condition that “the information processing apparatus 200 transmits power until the plug of the cable 230 is unplugged and disconnected from the connector unit 231”. “Own battery level” refers to a condition that “power transmission from the information processing apparatus 200 is stopped if the remaining battery level of the battery 212 of the information processing apparatus 200 reaches a predetermined value (predetermined ratio)” “Other battery level” refers to a condition that “power transmission from the information processing apparatus 200 is stopped if the remaining battery level of the external apparatus 900 reaches a predetermined value”. “Time passage” refers to a condition that “power transmission. or power reception is stopped if the duration of the power transmission or power reception reaches a predetermined time”. “Process completion” refers to a condition that “power transmission or power reception is stopped if processing of the information processing apparatus 200 relating to data transmission and reception is completed or if the information processing apparatus 200 enters a power saving mode”.

Columns 602 and 603 are used to set details of the condition set in the pulldown section 601 (remaining battery level or elapsed time). In the example of FIG. 6A, “time passage” is selected in the pulldown section 601. Therefore, a natural number (any one of 1 to 99) can be input to the column 602. A unit (either one of “minute(s)” and “hour(s)”) can be selected in the column 603.

FIG. 6B illustrates part of a screen further displayed on the window 501 if the slide bar 504 is operated to select the setting that the information processing apparatus 200 receives power, and the button 506 is operated to make detailed settings. The pulldown section 601 presents a selectable list of conditions (power reception stopping conditions) for stopping power reception by the information processing apparatus 200. The options selectable in the pulldown section 601 are similar to those of FIG. 6A, with only a difference that the conditions for stopping power transmission are replaced with ones for stopping power reception. Therefore, a detailed description thereof will thus be omitted.

In the example of FIG. 6B, “own battery level” is selected in the pulldown section 601. The unit in the column 603 is then fixed to %. A natural number (any one of 1 to 99) can be input to the column 602.

FIG. 7 illustrates details of the setting contents selectable in the pulldown section 509. “MTP” is a setting for transferring data between the information processing apparatus 200 and the external apparatus 900 based on the MTP. This setting is selected to make the information processing apparatus 200 function as an MTP initiator, and the external apparatus 900 as an MTP responder.

“PTP” is a setting for transferring data by PTP.

“Open Mass Storage” causes the external apparatus 900 to function as a mass storage device (USB mass storage class). The information processing apparatus 200 opens the top folder (or root folder) of the mass storage device of the external apparatus 900.

With the MTP, the information processing apparatus 200 serving as an MTP initiator can comprehend the file system of the external apparatus 900. This enables more favorable operation than when the external apparatus 900 is operated as a USB mass storage device, since self-access on the external apparatus 900 side and file access from the information processing apparatus 200 can be controlled not to conflict.

FIG. 8 illustrates details of the power control processing in step S106 of FIG. 1.

In step S801, the processor core 222 determines the direction of power transfer included in the instruction accepted in step S105. If the direction. of power transfer is a reception direction (YES in step S801), the processing proceeds to step S802. If the instruction accepted in step S105 includes the condition “neither transmit nor receive power” selected by the slider 505 in FIG. 5, the processing continues to loop in step S105 until either “transmit power” or “receive power” is selected by the slider 505.

In step S802, the processor core 222 determines whether the status of the information processing apparatus 200 is a power reception device (sink). If the information processing apparatus 200 is set as a power transmission device, the processor core 222 performs a role swap procedure to set the information processing apparatus 200 as a power reception device and the external apparatus 900 as a power transmission device. The reason is that when the information processing apparatus 200 and the external apparatus 900 establish a USB-PD connection therebetween, the role of a power reception device is assigned to either one of the apparatuses and the role of a power transmission device to the other as initial settings, which are reflected on the configuration registers of the respective apparatuses. The processor core 222 further outputs (transmits) to the external apparatus 900 a request for making the other apparatus function as a power transmission device so that the information processing apparatus 200 operates as a power reception device. Such a request is determined based on the capability information. received from the external apparatus 900 in step S101. More specifically, the USB control unit 210 outputs a request including, as requested power information, a power level (a set of a current value and a voltage value) requested by the information processing apparatus 200 among a plurality of possible power levels notified from the external apparatus 900 to the information processing apparatus 200. If a power reception stopping condition is set by the pulldown section 601, a USB control unit of the external apparatus 900 is set not to enter the power saving state. More specifically, the USB control unit 210 outputs a request in which the USB control unit 210 sets power saving limitation information (“No USB Suspend flag” in the request is set to 1).

In step S803, the USB control unit 210 of the information processing apparatus 200 performs power reception processing, and transmits and receives status information. The power reception is started after the request output in step S802 is accepted by the external apparatus 900 and a notification that the external apparatus 900 is ready for power transmission (power transmission ready) is confirmed to be issued. The USB control unit 210 outputs status information including the remaining level of the battery 212 of the information processing apparatus 200 to the external apparatus 900, and receives status information about the external apparatus 900.

In step S804, the processor core 222 determines whether the power reception stopping condition is satisfied, based on the status information about the information processing apparatus 200 or the external apparatus 900 and the power reception stopping condition. If the power reception stopping condition is not satisfied (NO in step S804), the processing proceeds to step S803 to continue the power reception processing. If the power reception stopping condition is satisfied (YES in step S804), the processing proceeds to step S805. In step S805, the processor core 222 performs power reception stop processing. The USB control unit 210 notifies the external apparatus 900 of a stop of power transmission. If the USB control unit of the external apparatus 900 is set not to enter the power saving state by the request of step S802, the external apparatus 900 clears the setting based on the notification.

In step S801, if the direction of power transfer is a transmission direction (NO in step S801), the processing proceeds to step S806. In step S806, the processor core 222 determines whether the status of the information processing apparatus 200 is a power transmission device. If the information processing apparatus 200 is set as a power reception device, the processor core 222 performs a role swap procedure to set the information processing apparatus 200 as a power transmission device and the external apparatus 900 as a power reception device. The USB control unit 210 further accepts a request from the external apparatus 900. If the accepted request includes a request to temporarily restrict the USB control unit 210 from entering the power saving state, the processor core 222 thus sets the configuration register of the register group 225.

In step S807, the USB control unit 210 of the information processing apparatus 200 performs power transmission processing, and transmits and receives status information. In starting power transmission, the USB control unit 210 notifies the external apparatus 900 that the request received from the external apparatus 900 is accepted in step S806 and that the information processing apparatus 200 is ready for power transmission. After notification that the external apparatus 900 is ready for power reception (power reception ready), the USB control unit 210 transmits power. The transmission and reception of the status information is similar to that in step S803. A description thereof will thus be omitted.

In step S808, the processor core 222 determines whether the power transmission stopping condition is satisfied, based on the status information about the information processing apparatus 200 or the external apparatus 900 and the power transmission stopping condition. If the power transmission stopping condition is not satisfied (NO in step S808), the processing proceeds to step S807 to continue the power transmission processing. If the power transmission stopping condition is satisfied. (YES in step S808), the processing proceeds to step S809. In step S809, the processor core 222 performs power transmission stop processing. Then, the USB control unit 210 notifies the external apparatus 900 of a stop of power transmission. If the USB control unit 210 is set not to enter the power saving state based on the request accepted in step S806, the processor core 222 accesses the configuration register to clear the setting when issuing the notification.

The USB control unit 210 also uses the CC pin for a power reception request and for transmission and reception of status information.

### <Connector Unit 231 and Cable 230>

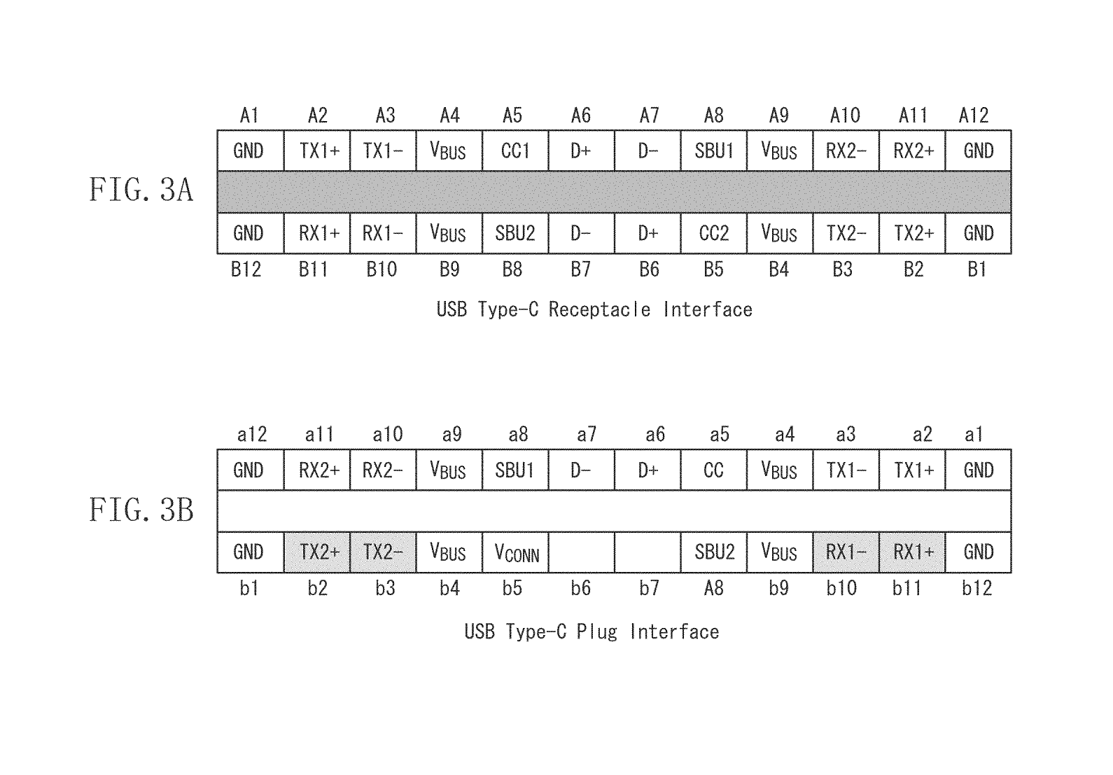

FIG. 3A illustrates a pin arrangement of a Type-C receptacle functioning as the connection units 228 and 229 of the connector unit 231.

USB Type-C defines a reversible plug having an oval cross section. The twelve pins on the A side have the same configuration as that of the twelve pins on the B side when reversed. Pins A1 (B1) and A12 (B12) are ground, and serve as paths for returning a return current. Pins A2 (B2) and A3 (B3) are differential signal lines for transmitting serial data compliant with the USB Super Speed mode from the information processing apparatus 200. Pin A4 (E4) is a bus power signal line that plays a main rote in power supply.

Pin A5 (B5) is a control signal line called CC. Pin A5 (B5) is used to perform a search (discovery) for USB devices, and control communication with a cable and the connected device. For example, the CC pin is used for transmission and reception processing of capability information in step S101 of FIG. 1 and to exchange various types of control information. In fact, either one of pins A5 and B5 that is connected to the CC pin on the plug side functions as CC. However, for ease of description, both pins A5 and B5 will be referred to as a CC pin.

Pins A6 (B6) and A7 (B7) are differential signal lines for USB 2.0-compliant data transfer. Pin A8 (B8) is a subsidiary signal line. Pin A8 (E8) is used in using a secondary bus function or extending the functionality of the interface. Pin A9 (B9) is used for bus power. Pin A9 (B9) is similar to the foregoing pin A4. Pins A10 (B10) and A11 (B11) are differential signal lines for the information processing apparatus 200 to receive serial data compliant with the USB Super Speed mode.

FIG. 3B illustrates a pin arrangement of a Type-C plug of the cable 230. If the plug is inserted into a receptacle serving as the connection unit 228 or 229, pin a1 of the plug is connected to pin A1 or B1 of the receptacle. Since the receptacle has upper and lower pins, i.e., two sets pins having equivalent functions, the plug inserted in a vertically inverted position connects similarly. To implement only USB 3.1 data transfer functions, the plug may include either one of the sets of pins a1 to a12 (hereinafter, referred to as set a) and b1 to b12 (hereinafter, referred to as set b). To supply a voltage corresponding to USB-PD, the V_{BUS} pins a4, a9, b4, and b9 may be needed. The V_{CONN} pin b5 may be used for search (discovery) for USB-PD devices and for other controls.

For ease of description, in the present exemplary embodiment, pins b2, b3, b10, and b11 are not used. Therefore, the cable 230 may include twelve signal lines (one of which is used for both GND and V_{BUS}).

### <Packet Format on CC Pin>

FIG. 4A illustrates a packet format for use in communication between the information processing apparatus 200 and the external apparatus 900 via the CC pin. A preamble 401 is binary data used for training on the reception side. A start of packet (SOP) 402 is 20-bit symbol data indicating a start of a packet. A header 403 and an object or objects 404 are part of a message (data to be interpreted on the protocol layer). The header 403 is 16-bit information, four bits (message type 421) of which indicate the type of message. Like 4-bit information illustrated in FIG. 4C, the message type 421 can indicate “0001: power transmission capability information (Source_Capabilities)” and “0100: power reception capability information (Sink_Capabilities).

The 32-bit object(s) 404 is/are the message contents. One message can include up to eight objects 404. The objects 404 may be omitted depending on the message type 421. For example, if the message type 421 is “0001: GoodCRC (good cyclic redundancy check (CRC))”, the objects 404 may be omitted. A CRC 405 is an error correction code. An end of packet (EOP) 406 is a symbol indicating an end of the packet.

The message type 421 illustrated in FIG. 4C indicates power transmission capability information. Actually, the message type 421 indicates a message including two types of content, an object 411 and an object 412, as the power transmission capability information. The object 411 indicates an initial state (vSafe5V) for power supply. The object 412 indicates that power can be supplied at 20 V and 5 A. FIG. 4D illustrates details of power transmission capability information 431 included in the object 412.

Power role information 432 indicates whether the information processing apparatus 200 can switch between the power transmission device and power reception device functions. Power saving support information 433 indicates whether the USB control unit 210 of the information processing apparatus 200 can enter the power saving mode. The power saving support information 433 can be reflected an the external apparatus 900. External power supply information 434 indicates whether the information processing apparatus 200 is mainly powered by an AC power supply. Data role information 435 indicates whether the information processing apparatus 200 can switch between data transmitter (host) and data receiver (device) functions. The power role information 432, the power saving support information 433, the external power supply information 434, and the data role information 435 can be expressed by one bit each. For example, being enabled can be expressed by 1, and being disabled by 0. In this case, when the information processing apparatus 200 can switch between the power transmission device and power reception device functions, will not enter the power saving mode, is not connected to an AC adapter, and can operate both as a host and as a device, the object 412 includes “1, 0, 0, 1”.

While the contents of the configuration register in the register group 225 are changed by the processor core 222 to cancel the Dual Role setting, the power role information 432 output from the information processing apparatus 200 to the external apparatus 900 is set to “0”.

### <Configuration Register and Status Register>

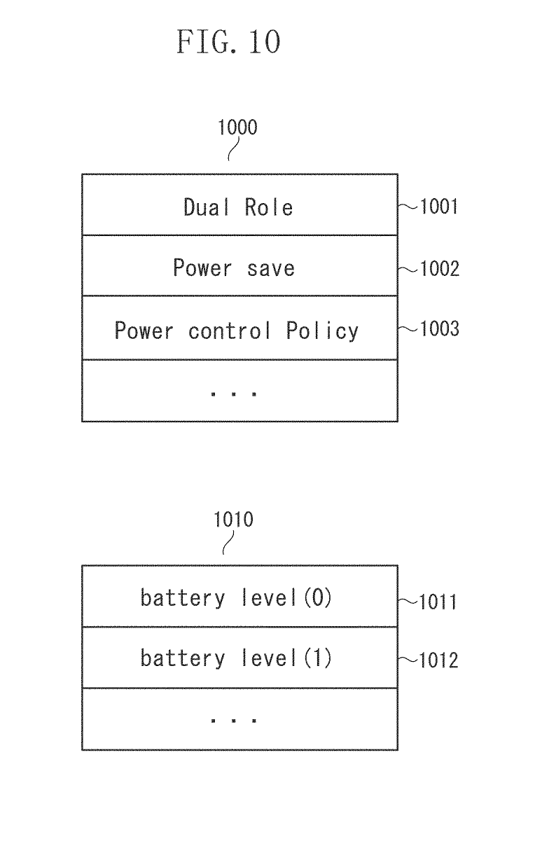

FIG. 10 illustrates an overview of a configuration register 1000 and a status register 1010 in the register group 225.

A field Dual Role 1001 indicates whether the Dual Role setting of the information processing apparatus 200 is enabled. In an.. initial state, the field Dual Role 1001 is set at “1 (Dual Role enabled)” which indicates that the information processing apparatus 200 can function both as a power transmission device and as a power reception device. If the processor core 222 makes register access to cancel the Dual Role setting, the field Dual Role 1001 is set to “0 (Dual Role disabled)”. The field Dual Role 1001 returns to “1” when initialized.

A field Power save 1002 indicates whether the USB control unit 210 is restricted from entering the power saving mode. In an initial state, the field Power save 1002 is set to “0 (restriction disabled)”. If the processor core 222 makes a setting to temporarily restrict the power saving mode in step S806, the field Power save 1002 is set to “1 (restriction enabled)” by a register access.

A field Power control policy 1003 stores the power control policy determined by the processor core 222 based on the contents of steps 5102 to 5105. For example, the field Power control policy 1003 stores role information indicating whether to make the information processing apparatus 200 function as a power transmission device or a power reception device or whether to omit power transfer, and a supplied power level (a value corresponding to a voltage value and a value corresponding to a current value). The field Power control policy 1003 also includes stopping condition information, an in-process flag, and a completion lag. The stopping condition information includes the power reception stopping condition or the power transmission stopping condition set via the window 501. The processor core 222 sets and enables the in-process flag if a ready signal is received from the external apparatus 900 in response to the request transmitted in step S802, or when a ready signal indicating readiness for power transmission is output based on the request accepted in step S806. The processor core 222 sets and enables the completion flag in the processing of step S809 or S805.

In the foregoing step S108, the UI 203 refers directly or indirectly to the field Power control policy 1003 and provides display corresponding to the obtained power control policy.

A field “battery level (0)” 1011 contains information indicating the remaining battery level of the battery 212 of the information processing apparatus 200. A field “battery level (1)” 1012 contains information indicating the remaining battery level of the external apparatus 900. The processor core 222 updates the remaining battery level of the external apparatus 900 if the remaining battery level is included in the capability information or status information obtained by the connector unit 231 from the external apparatus 900. If the UI 203 displays the time display 1104 in the foregoing step S108, the CPU unit 201 refers to the fields Power control policy 1003 and “battery level (0)” 1011 and calculates the display contents.

As described above, in the present exemplary embodiment, the information processing apparatus 200 uses a dual-role connector for power reception and power reception. Even in such a case, a notification corresponding to the control policy actually employed among a plurality of power control contents can be displayed, so that the user can easily confirm that the power control (including power level and direction of power transmission) intended by the user is in operation.

In a second exemplary embodiment, an information processing apparatus includes a plurality of USB Type-C connection units capable of both power transmission and power reception. The information processing apparatus displays which of the plurality of connection units transmits or receives the power intended by the user. Components and steps having functions similar to those of the first exemplary embodiment will be designated by the same reference numerals. A description of those that are similar in terms of configuration or function will be omitted.

In the present exemplary embodiment, the information processing apparatus 200 includes a plurality of connection units capable of both power transmission and power reception. The information processing apparatus 200 includes at least one or more connection units at each of two different ends of its outer casing.

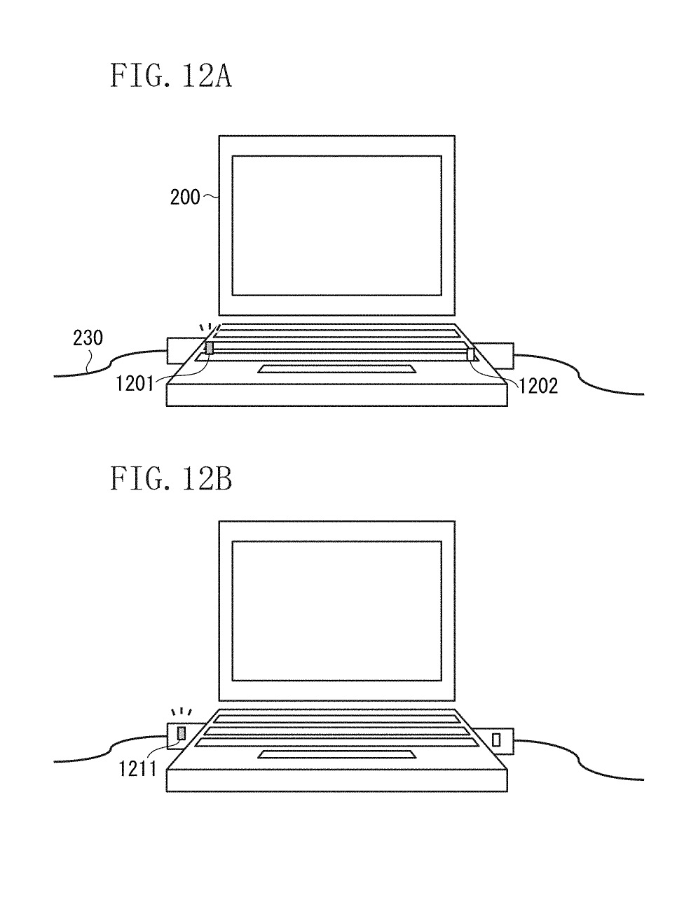

FIG. 12A illustrates an example of the information processing apparatus 200 which includes a connection unit 228 arranged at the left end (as seen from the user) of the outer casing, and a connection unit 229 arranged at the right end of the outer casing. The connection units 228 and 229 include light-emitting diodes (LEDs) 1201 and 1202 as a display unit, respectively. The processor core 222 performs control to turn on the LED 1201 or 1202 of the connection unit 228 or 229 that is used as an AC power supply or a power reception voltage of which is the highest among the connections connected to the connector unit 231. The processor core 222 determines the connection unit 228 or 229 that is used as an AC power supply or the power reception voltage of which is the highest based on the configuration register 1000 and/or the external power supply information 434.

In the example of FIG. 12A, the processor core 222 turns on the LED 1201. For example, if the information processing apparatus 200 depends on the power supply from the connection unit 228 with the battery 212 detached or with the battery 212 not functioning as a power supply (flat battery), the turning on of the LED 1201 can suppress unplugging of the cable 230 from the connection unit 228 by the user. The LED 1201 or 1202 of the connection unit 228 or 229 that is transmitting power may be turned on in different color. This allows the user to easily determine what power control is performed on which connection.

FIG. 12B illustrates an example in which a cable 230 includes an LED 1211. If the cable 230 is providing AC power supply, LED 1211 of the cable 230 is turned on. The cable 230 can interpret part of a message transmitted from the external apparatus 900 to the information processing apparatus 200, and an internal microcomputer (not illustrated) turns on the LED 1211 based on the external power supply information 434 included in the message. Aside from the LED 1211, configurations capable of notifying the user of a state, such as a liquid crystal display and sound, may be used.

As described above, according to the present exemplary embodiment, confusion of a power-transmitting or -receiving connection unit with another connection unit can be suppressed to reduce risks of disconnection of the connection, being mistaken for another connection, if a plurality of cables is connected. As illustrated in FIGS. 12A and 12B, the provision of the connection units at different ends of the information processing apparatus 200 allows the user to select in which direction to connect an AC power supply. This increases the degree of freedom of layout of the information processing apparatus 200.

In the foregoing exemplary embodiments, the cable(s) 230 supporting a CC signal line is/are described to be used. However, Type-A or Type-B cables may be used. Type-A and Type-B plugs may not support a CC signal line. In such a case, capability information may be transmitted. and received via a V_{BUS} pin instead of the CC pin.

In the foregoing exemplary embodiments, the disconnection of the cable 230 is detected as “non (detached)”. However, the disconnection may be detected by other methods. All messages transmitted from the information processing apparatus 200 to the external apparatus 900 are transmitted with a CRC. The external apparatus 900 returns a “GoodCRC” message in response to the CRC. Then, the disconnection may be determined if a “GoodCRC” message does not return within a predetermined time since the output of a message from the information processing apparatus 200.

In the present exemplary embodiments, for ease of description, a power transmission device and a power reception device are described to be switched in units of each information processing apparatus 200. However, the connection units may be individually controlled to be a power transmission device or a power reception device each. In such a case, components such as the configuration register and the status register may be provided as many as the number of connection units.

If the determination in step S102 or S103 is “YES”, the respective USB control units of the information processing apparatus 200 and the external apparatus 900 may be controlled not to enter the power saving mode.

If “YES” in step S102 or S103, or “NO” in S104, the UI 203 may make a notification about the determined power control policy without waiting for the acceptance of the user's instruction. The user may touch the notification to advance the processing to step S105. For example, even if the information processing apparatus 200 is powered by an AC power supply in step S102, the user may intend to disconnect the existing connection with the AC power supply once USB-PD power supply is established. If “YES” in step S102, the UI 203 may then display only a notification for accepting selection whether to replace the existing AC power supply with the USB-PD connection of which new control communication is established.

An exemplary embodiment of the present disclosure may be implemented by executing the following processing. The processing includes supplying software (program) for implementing the functions of the foregoing exemplary embodiments to a system or an apparatus via a network or various recording media, and reading and executing the program by a computer (or CPU or micro processing unit (MPU)) of the system or apparatus.

While the exemplary embodiments of the present disclosure have been described in detail above, the present disclosure is not limited to such specific exemplary embodiments, and various embodiments not departing from the gist of the present disclosure are also included in the present disclosure. Part of the foregoing exemplary embodiments may be combined as appropriate.

While exemplary embodiments have been described, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-132872, filed Jul. 4, 2016, which is hereby incorporated by reference herein in its entirety.

What is claimed is:

1. An information processing apparatus, comprising:
a first connection unit;
an acquisition unit configured to obtain capability information about an external apparatus from the external apparatus via the first connection unit;
a power control unit configured to control one of a plurality of states based on the capability information obtained by the acquisition unit, the plurality of states including a first state in which power is transmitted to the external apparatus via the first connection unit and a second state in which power is received from the external apparatus via the first connection unit; and
a notification unit configured to when the power control unit performs the control, distinguish and make a notification of the first state, the second state, and a third state different from the first and second states.

2. The information processing apparatus according to claim 1, wherein the notification unit is configured to further distinguish and make a notification of a state in which the information processing apparatus receives power from an external power supply and a state in which the information processing apparatus does not receive power from the external power supply.

3. The information processing apparatus according to claim 1,
wherein the power control unit is configured to be able to receive or transmit power at one of a plurality of power levels, and
wherein the notification unit is configured to make a notification of the power level at which the power control unit receives or transmits power.

4. The information processing apparatus according to claim 1, wherein the third state is a state in which the information processing apparatus is neither in the first state nor in the second state, and the information processing apparatus is driven by a battery.

5. The information processing apparatus according to claim 1, further comprising a register configured to store a power control policy indicating which state the information processing apparatus operates in,
wherein the notification unit is configured to make a notification based on the power control policy stored in the register.

6. The information processing apparatus according to claim 5, wherein the power control policy includes information about which of the plurality of states including the first and second states to operate the information processing apparatus in.

7. The information processing apparatus according to claim 5, wherein the power control policy includes information indicating a power transmission stopping condition in the first state or a power reception stopping condition in the second state.

8. The information processing apparatus according to claim 7, wherein the power reception stopping condition or the power transmission stopping condition is that a remaining battery level of the information processing apparatus reaches a predetermined ratio.

9. The information processing apparatus according to claim 7, wherein the power reception stopping condition or the power transmission stopping condition is that a remaining battery level of the external apparatus reaches a predetermined ratio.

10. The information processing apparatus according to claim 7, wherein the power reception stopping condition or the power transmission stopping condition is that a connection between the information processing apparatus and the external apparatus via the first connection unit is disconnected.

11. The information processing apparatus according to claim 7, wherein the power reception stopping condition or the power transmission stopping condition is that a duration of power reception or power transmission by the information processing apparatus via the first connection unit reaches a predetermined time.

12. The information processing apparatus according to claim 5, wherein the power control policy includes information indicating a power level to request to the external apparatus.

13. An information processing apparatus, comprising:
a USB Type-C connection unit;
an acquisition unit configured to obtain capability information about an external apparatus from the external apparatus via the connection unit;
a power control unit configured to controls one a plurality of states based on the capability information obtained from the acquisition unit, the plurality of states including a first state in which power is transmitted to the external apparatus via the connection unit and a second state in which power is received from the external apparatus via the connection unit; and
a notification unit configured to, when the power control unit performs the control, distinguish and make a notification of the second state and a state in which power is received from an AC power supply via a path different from the connection unit.

14. An information processing apparatus comprising:
a first connection unit;
an acquisition unit configured to obtain capability information from an external apparatus via the first connection unit, the capability information including information indicating a plurality of power levels at which the external apparatus is capable of supplying power and a power level at which the external apparatus is capable of receiving power;
a power control unit configured to control one of a plurality of states including a power transmission state in which power is transmitted to the external apparatus via the first connection unit and a power reception state in which power is received from the external apparatus via the first connection unit; and
a notification unit configured to, when the power control unit controls the power reception state or the power transmission state, make a notification corresponding to a power level at which power is received or transmitted.

15. An information processing apparatus, comprising:
a first connection unit;
a second connection unit;
a power control unit configured to control one of a plurality of states including a power transmission state in which power is transmitted to an external apparatus via the first or second connection unit and a power reception state in which power is received from the external apparatus via the first or second connection unit; and
a notification unit configured to, when the power control unit controls the power reception state, distinguish and make a notification of a connection unit receiving power at a higher power level between the first and second connection units.

16. The information processing apparatus according to claim 15, wherein the first and second connection units are arranged at different ends of the information processing apparatus.

17. An information processing method of an information processing apparatus including a first connection unit, the method comprising:
obtaining capability information about an external apparatus from the external apparatus via the first connection unit;
controlling one of a plurality of states based on the obtained capability information, the plurality of states including a first state in which power is transmitted to the external apparatus via the first connection unit and second state in which power is received from the external apparatus via the first connection unit; and
distinguishing and making a notification of the first state, the second state, and a third state different from the first and second states when the control is performed.

18. An information processing method of an information processing apparatus including a USB Type-C connection unit, the method comprising:
obtaining capability information about an external apparatus from the external apparatus via the connection unit;
controlling one of a plurality of states based on the obtained capability information, the plurality of states including a first state in which power is transmitted to the external apparatus via the connection unit and a second state in which power is received from the external apparatus via the connection unit; and
distinguishing and making a notification of the second state and a state in which power is received from an AC power supply via a path different from the connection unit.

19. An information processing method of an information processing apparatus including a first connection unit, the method comprising:
obtaining capability information from an external apparatus via the first connection unit, the capability information including information indicating a plurality of power levels at which the external apparatus is capable of supplying power and a power level at which the external apparatus is capable of receiving power;
controlling one of a plurality of states including a power transmission state in which power is transmitted to the external apparatus via the first connection unit and a power reception state in which power is received from the external apparatus via the first connection unit; and
making a notification of the power reception state or the power transmission state, the notification corresponding to a power level at which power is received or transmitted.

20. An information processing method of an information processing apparatus including a first connection unit and a second connection unit, the method comprising:
performing power control based on one of states including a power transmission state in which power is transmitted to an external apparatus via the first or second connection unit and a power reception state in which power is received from the external apparatus via the first or second connection unit; and
distinguishing and making a notification of a connection unit receiving power at a higher power level between the first and second connection units.

21. A recording medium recording a computer-readable program for causing a computer including a first connection unit to function as:
an acquisition unit configured to obtain capability information about an external apparatus from the external apparatus via the first connection unit;
a power control unit configured to control one of a plurality of states based on the capability information obtained by the acquisition unit, the plurality of states including a first state in which power is transmitted to the external apparatus via the first connection unit and a second state in which power is received from the external apparatus via the first connection unit; and
a notification unit configured to, when the power control unit performs the control, distinguish and make a notification of the first state, the second state, and a third state different from the first and second states.

22. A recording medium recording a computer-readable program for causing a computer including a USB Type-C connection unit to function as:
an acquisition unit configured to obtain capability information about an external apparatus from the external apparatus via the connection unit;
a power control unit configured to control one of a plurality of states based on the capability information obtained by the acquisition unit, the plurality of states including a first state in which power is transmitted to the external apparatus via the first connection unit and a second state in which power is received from the external apparatus via the connection unit; and
a notification unit configured to, when the power control unit performs the control, distinguish and make a notification of the second state and a state in which power is received from an AC power supply via a path different from the connection unit.
